(19) United States
(12) Patent Application Publication
(10) Pub. No.: US 2025/0319488 A1
(43) Pub. Date: Oct. 16, 2025

(54) METHOD AND INSTALLATION FOR APPLYING A LIQUID COATING TO A STRIP MOVING CONTINOUSLY AND TRAVELLING DOWNWARDS

(71) Applicant: John Cockerill S.A., Seraing (BE)

(72) Inventors: Eric GOREUX, Fexhe-le-Haut-Clocher (BE); Enrico TIRELLI, Villers-aux-Tours (BE)

(21) Appl. No.: 18/862,969

(22) PCT Filed: Mar. 1, 2023
(86) PCT No.: PCT/EP2023/055213

§ 371 Date: Nov. 5, 2024

(30) Foreign Application Priority Data
May 23, 2022 (EP) 22174939.3

(51) Int. Cl. B05C 15/00; B05D 3/02

(52) U.S. Cl. CPC B05C 15/00; B05D 3/0272

(57) ABSTRACT

An installation for coating a substrate comprising a steel strip with a liquid, the steel strip moving continuously and in a vertical downward strand, as a coated strip, the installation including, successively from top to bottom: a coating unit; a baking or drying unit including at least one oven; a re-treatment unit for continuously re-treating residual vapors emitted by the baking or drying unit; an entry aerodynamic airlock system and an exit aerodynamic airlock system located at an entrance and an exit, respectively, of the baking or drying unit; in the baking or drying unit, an entrance near the exit aerodynamic airlock for injecting hot gas and an exit near the entry aerodynamic airlock for extracting the hot gas towards the re-treatment unit; and a rapid liquid cooling unit. The coated strip does not come into mechanical contact with any part of the installation.

### CROSS-REFERENCE TO PRIOR APPLICATIONS

This application is a U.S. National Phase application under 35 U.S.C. § 371 of International Application No. PCT/EP2023/055213, filed on Mar. 1, 2023, and claims benefit to European Patent Application No. EP 22174939.3, filed on May 23, 2022. The International Application was published in French on Nov. 30, 2023 as WO/2023/227264 under PCT Article 21(2).

### FIELD

The present invention relates to the field of coating substrates such as strips with a liquid, more particularly the coating of continuously moving metal strips with a paint, a varnish, a thin organic coating or any other surface treatment.

More particularly, the invention relates to the field of electrical coating for steel sheets with an insulating varnish (or lacquer), which subsequently makes it possible, due to the adhesiveness thereof, to bond the sheets by stacking, for the production of electrical cores.

### BACKGROUND

It is known that the application of a coating liquid to a continuously moving strip, e.g. a steel strip, is generally carried out in upward pass.

FIG. 1 shows an example of embodiment according to the prior art. The steel strip 10, after degreasing/cleaning, first passes through a roll coating unit 4, making it possible, in the example chosen, to apply one or two liquid preparations 41, 42 and then passes, preferably after inspection and validation by a camera and wet gauge system, into an oven 3, such as an induction or infrared oven, for baking the coating. At the end of the baking process, the volatile organic compounds are treated in an ad hoc unit 5. When leaving the oven 3, the coated strip 12 changes direction at the deflection top roll 2 and is then subjected to water cooling in a water cooling unit 6 and to hot air drying in a dryer 7, before being directed toward an exit accumulator 8.

At present, the rapidly growing automotive electric/hybrid vehicle market is particularly demanding of steel sheets that have undergone a pre-coating, i.e. which are coated with an insulating varnish, so as to equip the manufactured electric motors.

In electrical engineering, assemblies of soft iron laminated sheets are used to produce the magnetic circuits of coils (electromagnets, transformers, rotating machines, etc.). Such sheets are coated with an insulating varnish to limit the circulation of stray currents (eddy currents) and thus the overheating of the magnetic circuit and iron losses, which are proportional to the square of the frequency. The preparation of the insulating varnish may comprise, in aqueous or organic phase, a thermosetting resin, e.g. an epoxide, polyester, acrylic, phenolic, silicone resin, etc.

As regard to the production of magnetic cores, and after cutting, the coated sheets are compressed and heated. Thereby, the baking of insulating varnish is carried out in two steps: a first time in the present line and a second time at the engine manufacturer. Which means that the baking of the varnish is not complete when touching the top deflection roll of the line, hence an unwanted phenomenon of sticking or adhesion is present. This phenomenon could also occur with other types of coatings and for different reasons. On the other hand, for conventional insulating varnishes, the baking is complete when the strip reaches the top roll and there is no adhesion problem.

A mechanical contact of the coating, not completely dried in the coating installation, more particularly in contact with the top roll of the installation in upward strand, may clog the roll and damage the coating, which would thus not meet the required criteria and more particularly a minimum thickness of the adhesive layer. The adhesive layer should not be too thick either. One possibility would be to insert an additional cooling section without contact, e.g. an air cooling section, between the exit of the induction oven 3 and the top roll 2, which is what was already recommended in document FR 2 768 157 in the case of a galvanizing installation. After the induction oven, the strip is cooled so that the coating is not damaged when passing over the top deflection roll.

However, it should be noted that there is a fundamental difference between galvanizing, which does not release solvents, and varnishing (paint), where solvents may be condensed by an air flow. The cooling of the varnished or painted strip is thus done with water to prevent the condensation of solvents. Some of the solvents are found in the water to such an extent that the water tank has to be periodically cleaned of “creamy” deposits coming from diluted solvents.

It should also be noted that the word “solvent” is used in the text by misuse of language, but in reality, the “solvents” may also consist in residual fumes, gases or vapors that escape from the sheet metal after baking and that come e.g. from hardeners and are then in the form of blue, pungent fumes.

Furthermore, the travel speeds of the strips are very high and the air cooling rates are slow. This solution implies, in upward strand, a very long drying length and thus the height of the installation must be greatly increased. Even though placing a water cooling unit at the top of the installation is not a major technical problem, such unit cannot, in the case of varnishing, be located above the ovens because it is impossible to collect the water and a deflection roll has to be installed before the water cooling.

Document FR 2 640 890 A1 discloses an installation for depositing and drying a liquid coating on a continuous strip of sheet metal, such as a continuous lacquering installation. The sheet passes successively through a preparatory treatment station and then through at least one coating and drying station, wherein the sheet moves vertically downwards. The latter station comprises, in the order of passage of the strip, a device for coating the sheet metal strip, then induction or infrared heating means that evaporate the solvent and polymerize the binder, and the strip then passes into a cooling device preferably comprising a tank which is filled with cooling liquid, and wherein a guide or deflection roll changing the direction of the sheet metal strip is placed.

This technology, illustrated schematically in FIG. 2, has as such, difficulties preventing its implementation. Indeed, placing a solvent-based coating chamber above a thermal equipment represents a considerable danger both in terms of explosiveness and also health for the personnel working near the coating chamber. Finally, it is not uncommon for fires to occur due to the combustion of condensed solvents in ovens or in flue systems.

Explosions in solvent flue systems are rare but require ad hoc devices to channel the shock wave. The damage may be significant, especially in hot air ovens, which represent a large explosive volume compared to induction ovens, which are much shorter and have particularly small cross-sections (approximately 2000 mm×200 mm) compared to a cross-section of several m² for hot air ovens (approximately 2500 mm×2500 mm).

As regard to health concerns, coating chambers are generally maintained at a slightly positive pressure compared to their surroundings so as to limit the entry of dust that may contaminate the paint. The ovens are also kept at a much lower pressure than the chambers to avoid the entry of toxic solvents into the room where operators are located. The solvent extraction fan is thus a major element in the overall safety system of the plant. The path of solvent-laden air in hot air ovens is transverse to the strip with suction flow rates suitable for the quantity of solvent generated per oven area.

On paint lines with strips traveling above 100 m/min, it can be seen that without a well-designed barrier system, a flow of hot air is noticeable on coating machines, despite the negative pressure setpoint maintained between the ovens and the coating room. This effect, which can be described as “dynamic”, is all the more noticeable as the air flow rates are high and related to the productivity of the line, and hence to the quantities of solvents to be evaporated (which may involve quantities of solvent to be discharged close to 500 kg/hour).

As a summary, a downward-pass coating as in FR 2 640 890 A1 would take place in counterflow mode between the hot air and the strip. Same should include a thermal system under the coating unit and end with a water cooling, which has the advantage of not requiring an intermediate deflection roll, which damages a coating that has not completely dried while becoming clogged.

Nevertheless, this principle poses at the present time a serious problem of pollution of the coating chamber following an escape of air heavily laden with solvents, despite the low pressure of the ovens compared to the chamber, which tends to go against the gravitational forces acting on the hot air.

### SUMMARY

In an embodiment, the present invention provides an installation for coating a substrate comprising a steel strip with a liquid, the steel strip moving continuously and in a vertical downward strand, as a coated strip, the installation comprising, successively from top to bottom: a coating unit; a baking or drying unit comprising at least one oven; a re-treatment unit for continuously re-treating residual vapors emitted by the baking or drying unit; an entry aerodynamic airlock system and an exit aerodynamic airlock system located at an entrance and an exit, respectively, of the baking or drying unit; in the baking or drying unit, an entrance near the exit aerodynamic airlock for injecting hot gas and an exit near the entry aerodynamic airlock for extracting the hot gas towards the re-treatment unit; and a rapid liquid cooling unit, wherein the installation is configured so that the coated strip does not come into mechanical contact with any part of the installation between the exit of the baking or drying unit and the rapid liquid cooling unit, before the coated strip returns to room temperature, wherein each of the entry aerodynamic airlock system and the exit aerodynamic airlock system includes, on each side of the strip, a suction chamber configured to draw gases from the baking or drying unit, and a reinjection chamber equipped with nozzles, an orientation of the nozzles allowing reinjection of a first part of gases drawn along the strip towards the baking or drying unit, a second part of the gases drawn along the strip being sent into the re-treatment unit, the baking or drying unit and the rapid liquid cooling unit being at a low pressure relative to surroundings of the installation, and the coating unit being at overpressure relative to the surroundings.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 schematically represents an installation for coating a steel sheet with a liquid according to a first embodiment of the prior art.

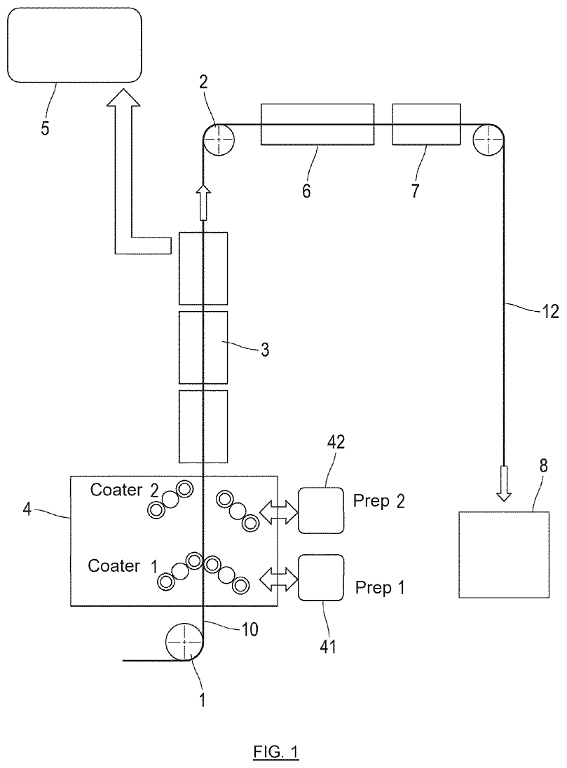

FIG. 2 schematically represents an installation for coating a steel sheet with an insulating varnish according to a second embodiment of the prior art.

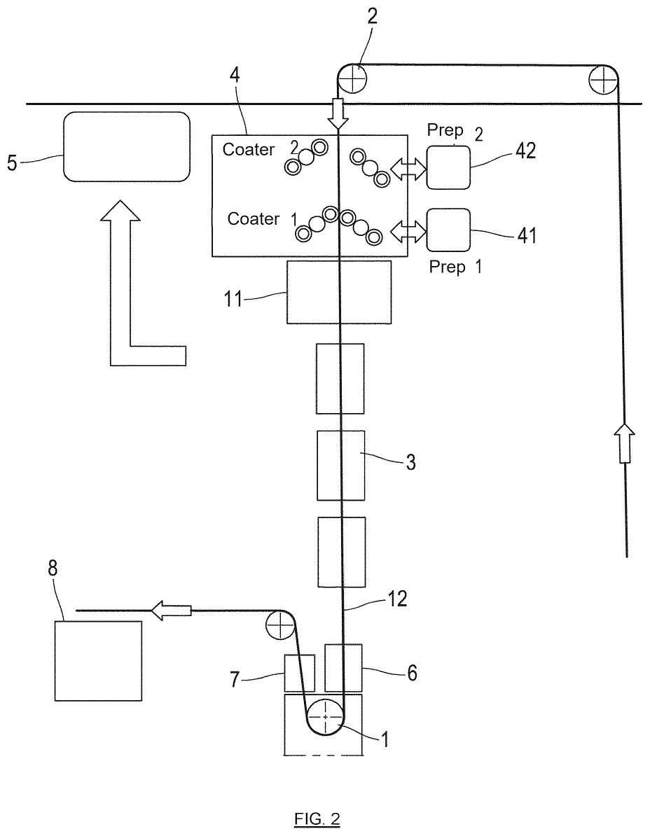

FIG. 3 schematically represents an installation for coating a steel sheet with an insulating varnish according to one embodiment of the invention.

FIG. 4A schematically represents an example of an upper aeraulic/aerodynamic airlock (oven entrance) in a use according to the invention.

FIG. 4B schematically represents an example of a lower aeraulic/aerodynamic airlock (oven exit) in a use according to the invention.

### DETAILED DESCRIPTION

In an embodiment, the present invention provides a method and an installation for coating a continuously moving strip by means of a liquid, without the risk of damaging the coating by contact with a deflection roll before the strip has completely cooled.

A first aspect of the present invention relates to a method for coating a substrate in the form of a steel strip with a liquid, the steel strip moving continuously at a speed greater than 80 meters/minute in a vertical downward strand section, comprising at least the following steps:
(a) providing a steel strip after cleaning and/or stripping
(b) providing at least one liquid coating preparation
(c) applying said liquid coating preparation to the steel strip in a coating unit, so as to obtain a coated strip
(d) drying or baking the coating of the coated steel strip by passing the strip through a baking unit comprising at least one oven up to a temperature of at least 100° C., so that the coating is not completely dried or baked, and equipped with an atmosphere insulation system
(e) cooling the coated steel strip at the exit of the oven, in a liquid cooling unit;
so as to avoid mechanical contact of the coated strip after leaving the baking unit and before returning to ambient temperature in the liquid cooling unit;
said method being characterized in that the baking unit is isolated by a system with two aeraulic/aerodynamic airlocks, located at the entrance and exit, respectively, of the baking unit, so as to form therein a dynamic pressure on the strip and to prevent the coating unit and/or the liquid cooling unit from being contaminated by residual vapors from the baking unit, a hot gas, preferably at a temperature of about 250° C., being injected into the baking unit, in the vicinity of the exit aeraulic/aerodynamic airlock, or extracted from the entrance aeraulic/aerodynamic airlock, respectively, the gas flowing counter to the coated steel strip, so as to avoid condensation cold spots due to the residual vapors.

According to preferred embodiments of the invention, the coating method further comprises at least one of the following features or an appropriate combination of a plurality thereof:
the residual vapors emitted by the baking unit are continuously extracted for re-treatment in a re-treatment unit;
the hot gas extracted at the exit aeraulic/aerodynamic airlock has a temperature between 180 and 250° C. and is sent to the re-treatment unit;
the coating liquid is an electrically insulating varnish or paint
the coating liquid is a thermosetting epoxide, polyester, acrylic, phenolic or silicone resin, in an aqueous or organic phase, or a zinc composition for e.g. passivation or phosphating treatment
the method further includes a step (f) of drying the coated strip in a hot air dryer
the coating unit is a roll coating unit or a spraying unit
the steel strip is an electrical steel strip intended for use as a magnetic laminated steel sheet in the field of electrical engineering or electronics.

A second aspect of the present invention relates to an installation for coating a substrate in the form of a steel strip with a liquid, the steel strip moving continuously and at least partly in vertical downward strand, characterized in that same comprises successively from top to bottom:
a coating unit;
a baking or drying unit;
an aerodynamic airlock system located at the entrance and exit, respectively, of the baking or drying unit;
in the baking unit, an entrance near the exit aerodynamic airlock for injecting hot gas and an exit near the entry aerodynamic airlock for extracting said hot gas towards a unit for continuously re-treating residual vapors emitted by the baking unit;
a rapid liquid cooling unit;
said unit for continuous re-treatment of residual vapors emitted by the baking unit;
configured so that the coated strip does not come into mechanical contact with any part of the installation between the exit of the baking unit and the rapid liquid cooling unit, before the coated strip returns to room temperature.

According to preferred embodiments of the invention, the coating installation comprises at least one of the following features or an appropriate combination of a plurality thereof
the installation includes a contactless anti-dripping device located after the exit of the coating unit;
the rapid liquid cooling unit comprises a liquid bath wherein a deflection roll is located, said bath being preceded, if appropriate, by liquid spray jets;
each of the aerodynamic airlocks comprises, on each side of the strip in use, a suction chamber that draws gases coming from the baking unit and a re-injection chamber equipped with nozzles, the orientation of which allows the reinjection of part of the gases drawn along the strip towards the baking unit, another part of the drawn gases being sent to the re-treatment unit;
the baking unit is at a low pressure compared to the surroundings and to the coating unit;
reinforced movable valves are placed between the coating unit and the entry airlock of the baking unit, so as to physically close the entry airlock in the event of fire or of danger of explosion.

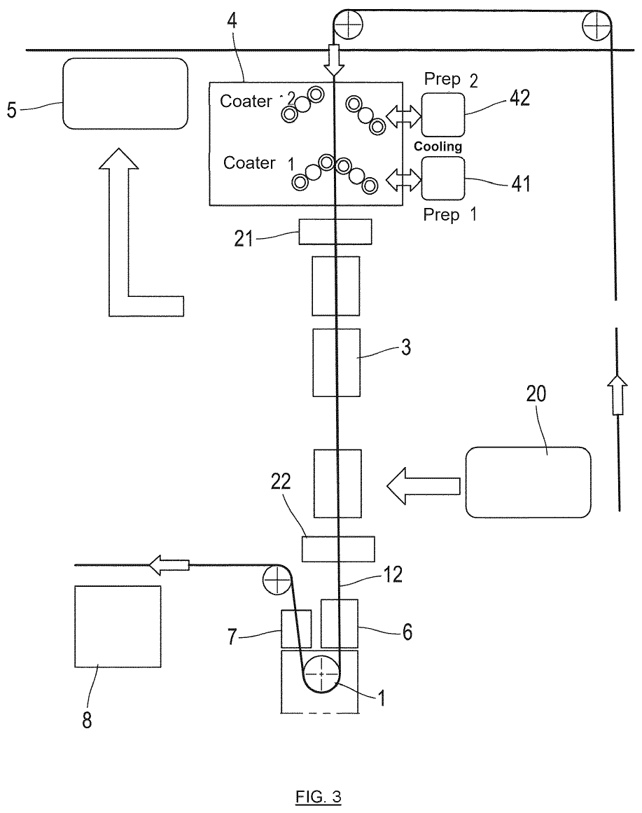

A solution provided by the invention is represented according to the embodiment shown in FIG. 3. The general idea is to move the strip continuously in downward strand, while bypassing the difficulties that are encountered by implementing the basic technology according to document FR 2 640 890 A1. In this configuration, a water cooling unit 6 in a closed loop circuit is installed after the exit of the baking unit 3 with one or a plurality of ovens, near the lowest point of the installation. Since the coating is already cooled by water and, in addition, the lower deflection roll I is in the water, the quality of the coating is not affected in said configuration when the strip passes over the deflection roll because the temperature at said place is close to ambient temperature.

The specificity of the present invention is to be able to exploit a continuous coating line for a metal strip in downward pass without damaging a coating that is not completely dry, which is necessary in certain applications, while avoiding the risks of explosion and/or fire associated with the solvent as described hereinabove. The major advantage of the downward-pass coating, unlike the upward-pass coating, is that a complete cooling of the sheet metal (i.e. to ambient temperature) can be performed before the first physical/mechanical contact, which is the contact with a deflection roll, and without using vigorous air blowing, which condenses the solvents on the cooling device and causes significant vibration of the strip as well as condensation of the smoke from the hardeners on the blowing systems, but instead using water sprinkling or immersion.

Despite the difficulties described above (risk of explosion, risk to the health of operators, risk of polluting the coating unit and the water cooling), this principle should advantageously be reconsidered at the present time because same makes possible the application of viscous varnish allowing steel sheets to be stacked, e.g. for the manufacture of air gaps for electric motors.

Since contact with a deflection roll prior to complete cooling (i.e. approximately to ambient temperature) is prohibited, upward-pass coating should certainly be excluded. This method would indeed result, for productivity such as 30 tons per hour per meter wide as aforementioned, in enormous cooling lengths with the risks of strip vibration associated with the length of the equipment and the airflow. It could also result in a condensation of residual emissions on cold air blowing structures and in a pollution of the surrounding atmosphere.

In the downward pass, only the design of an extremely efficient barrier system is suitable for limiting the concentration of solvents to a content corresponding to natural evaporation at the ambient temperature of the chamber, more particularly in the coating chamber located at the top of the tower.

To this end, the inventors have developed an aeraulic/aerodynamic airlock (called Aeroven™) making it possible to realistically envisage a downward-pass coating.

Indeed, this system integrates an oriented recovery, e.g. with deflectors with an inclination of 30° with respect to the horizontal and recirculation followed by homogeneous blowing, which is also oriented. The high-speed circulation loop requires a fan with a capacity greater than 10,000 Pa. The system includes a discharge or intake with a flow that is controlled independently of the blowing speed for a local depression or overpressure and a physical barrier adjustable according to the operating conditions. The airlocks are located just below or above the fresh air supply loops or solvent-laden air recovery loops, while providing sufficient access for possible maintenance interventions.

These elements makes it possible to maintain both tolerably healthy surroundings, in the coating chamber (due to an upper airlock) and a reasonable cleanliness of the water spray system (due to a lower airlock) by limiting contamination towards the two chambers located at the top and at the bottom, respectively, of the ovens.

It should be noted that the downward-pass installation according to the invention can be either controlled by at least one operator located on the upper floor (where the applicators are located) and at least one operator located on the ground floor (where the oven is situated), or controlled in a centralized manner by only one operator.

A detailed example illustrating the implementation of the invention is described hereinafter.

For this purpose, an aeraulic/aerodynamic airlock 21, 22 should be provided at the top (entrance) and at the bottom (exit), respectively, of the area 3 of the ovens.

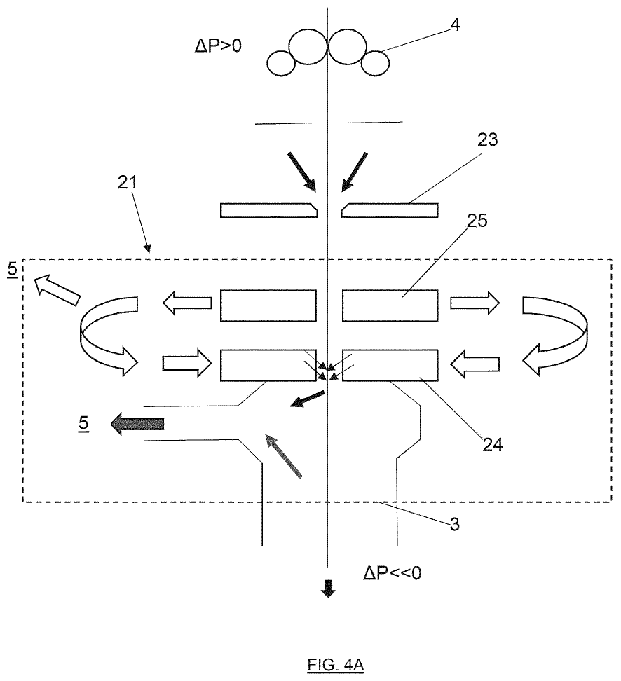

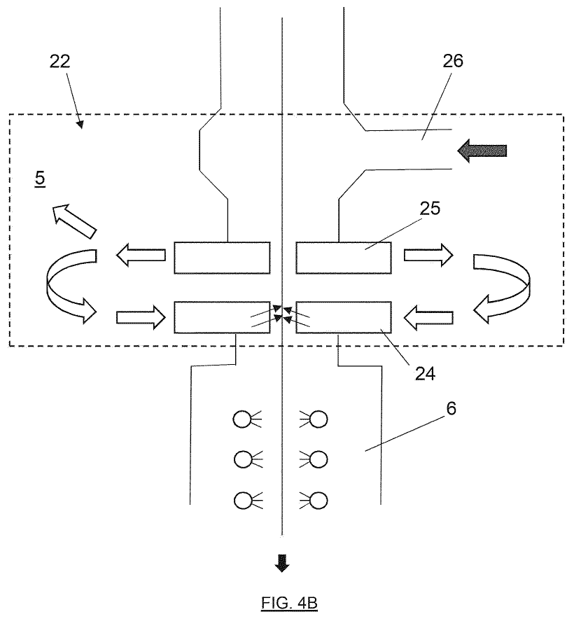

Firstly, according to an embodiment shown in FIG. 4A, provision will be made, via reinforced movable valves 23, for the possibility of partial or complete physical closure of the entry airlock 21 in the event of fire or danger of explosion, which makes it possible to protect the personnel against such type of incident.

The entry airlock 21 of the ovens consists, on each side of the strip, successively of chambers 25, 24 for drawing and reinjecting air (with recirculation), respectively. The suction chambers 25 draw both the cold air entering from the coating unit 4 and the hot air rising from the ovens 3, while the chambers 24 re-inject the drawn air. This system creates an aerodynamic plug that will prevent the hot air from the ovens 3, containing solvents, from contaminating the coating area 4. The hot air laden with solvents is then finally drawn at the top of the ovens towards the Volatile Organic Compound (VOC) treatment unit 5. More particularly, the chambers 24 and/or 25 include nozzles, the orientation of which is suitable for producing the aerodynamic plug. The coating area 4 is maintained at a slight overpressure with respect to the surroundings, while the area of the ovens 3 is maintained at a low pressure.

Still according to said embodiment, represented in FIG. 4B, the exit airlock 22 of the ovens 3 is also composed, on each side of the strip, successively of chambers 25, 24 for drawing and injecting hot air (with recirculation), respectively. High flow-rate hot air (e.g. at 250° C.) is injected at the bottom of the oven area 26. Part of the hot air is thus drawn and reinjected by the airlock, a further part of which is redirected to the VOC treatment unit 5. Most of the injected hot air flows counter to the strip before being discharged towards the VOC treatment unit 5. The water-cooling chamber (in the present case by sprinkling) 6 is maintained at a low pressure compared to the surroundings.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### List of Reference Symbols

1 Deflection bottom roll
2 Deflection top roll
3 Baking unit (oven)
4 Roll coating unit
5 Volatile Organic Compound treatment unit
6 Water-cooling unit
7 Hot air dryer
8 Accumulator
10 Continuously moving steel strip
11 Station with wet gauge and camera
12 Coated steel strip
20 Injection of hot gas
21 Upper aeraulic/aerodynamic airlock
22 Lower aeraulic/aerodynamic airlock
23 Reinforced movable valve
24 Air injection chamber
25 Air suction chamber
26 High flow-rate hot air injection
41, 42 Resin preparation

1-14. (canceled)

15. An installation for coating a substrate comprising a steel strip with a liquid, the steel strip moving continuously and in a vertical downward strand, as a coated strip, the installation comprising, successively from top to bottom:
a coating unit;
a baking or drying unit comprising at least one oven;
a re-treatment unit for continuously re-treating residual vapors emitted by the baking or drying unit;
an entry aerodynamic airlock system and an exit aerodynamic airlock system located at an entrance and an exit, respectively, of the baking or drying unit;
in the baking or drying unit, an entrance near the exit aerodynamic airlock for injecting hot gas and an exit near the entry aerodynamic airlock for extracting the hot gas towards the re-treatment unit; and
a rapid liquid cooling unit,
wherein the installation is configured so that the coated strip does not come into mechanical contact with any part of the installation between the exit of the baking or drying unit and the rapid liquid cooling unit, before the coated strip returns to room temperature,
wherein each of the entry aerodynamic airlock system and the exit aerodynamic airlock system includes, on each side of the strip, a suction chamber configured to draw gases from the baking or drying unit, and a reinjection chamber equipped with nozzles, an orientation of the nozzles allowing reinjection of a first part of gases drawn along the strip towards the baking or drying unit, a second part of the gases drawn along the strip being sent into the re-treatment unit, the baking or drying unit and the rapid liquid cooling unit being at a low pressure relative to surroundings of the installation, and the coating unit being at overpressure relative to the surroundings.

16. The installation of claim 15, further comprising:
a contactless anti-dripping device located after the exit of the coating unit.

17. The installation of claim 15, wherein the rapid liquid cooling unit comprises a liquid bath, and
wherein a deflection roll is located, the bath being preceded, if appropriate, by liquid spray jets.

18. The installation of claim 15, further comprising:
reinforced movable valves are arranged between the coating unit and the entry aerodynamic airlock system of the baking or drying unit so as to physically close the entry aerodynamic airlock system in case of fire or danger of explosion.

19. A method implementing the installation of claim 15 for coating the substrate comprising the steel strip with a liquid, the steel strip moving continuously at a speed greater than 80 meters/minute in a vertical downward strand section, the method comprising:
(a) providing the steel strip after cleaning and/or stripping;
(b) providing at least one liquid coating preparation;
(c) applying the at least one liquid coating preparation to the steel strip in the coating unit so as to obtain a coated steel strip;
(d) drying or baking a coating of the coated steel strip by passing the coated steel strip through the baking or drying unit, the baking or drying unit comprising an atmosphere insulation system, up to a temperature of at least 100° C., so that the coating is not completely dried or baked;
(e) cooling the coated steel strip at the exit of the baking or drying unit, in the rapid liquid cooling unit so as to avoid mechanical contact of the coated strip after leaving the baking or drying unit and before returning to ambient temperature in the rapid liquid cooling unit,
wherein the baking or drying unit is isolated by the atmosphere insulation system, which-includes two aeraulic/aerodynamic airlocks, located at the entrance and exit, respectively, of the baking or drying unit, so as to form therein a dynamic pressure on the coated steel strip and to prevent the coating unit and/or the rapid liquid cooling unit from being contaminated by residual vapors from the baking or drying unit, a hot gas being injected into the baking or drying unit, in a vicinity of the exit aeraulic/aerodynamic airlock, or extracted from the entry aeraulic/aerodynamic airlock, respectively, the hot gas flowing counter to the coated steel strip so as to avoid condensation cold spots due to the residual vapors.

20. The method of claim 19, wherein the residual vapors emitted by the baking or drying unit are continuously extracted for re-treatment in the re-treatment unit.

21. The method of claim 19, wherein the hot gas extracted at the exit aeraulic/aerodynamic airlock has a temperature between 180 and 250° C. and is sent to the re-treatment unit.

22. The method of claim 19, wherein the coating liquid comprises an electrically insulating varnish or paint.

23. The method of claim 19, wherein the coating liquid comprises at least one of a thermosetting epoxide, polyester, acrylic, phenolic or silicone resin, in an aqueous or organic phase, and/or a zinc composition.

24. The method of claim 19, further comprising:
drying the coated strip in a hot air dryer.

25. The method of claim 19, wherein the coating unit comprises a roll coating unit or a spraying unit.

26. The method of claim 19, wherein the steel strip comprises an electrical steel strip for use as a magnetic laminated steel sheet.

27. The method of claim 19, wherein the hot gas is at a temperature of about 250° C.
